(19) United States
(12) Patent Application Publication
(10) Pub. No.: US 2007/0064298 A1
(43) Pub. Date: Mar. 22, 2007

(54) Four-hinge micromirror with 3 degrees of freedom

(76) Inventor: Yijian Chen, Albany, CA (US)

Correspondence Address: Yijian Chen, 1049 Talbot Avenue, Albany, CA, 94706, US

(21) Appl. No.: 11/229,405

(22) Filed: Sep. 19, 2005

(51) Int. Cl. G02B 26/00

(52) U.S. Cl. 359/291

(57) ABSTRACT

A four-hinge micromirror with 3 degrees of freedom has been invented. The size of the micromirrors can vary in a wide range from more than 10 μm to sub-1 μm. An example of CMOS-compatible low temperature SiGe process flow to fabricate this device using different structural and sacrificial materials is proposed. Electrical (resistive) damping can be introduced by controlling the doping level of the SiGe hinges and posts. The applications include optical display and projection systems such as high-definition projection TV, optical switching systems, and maskless lithography.

A four-hinge micromirror has been invented for optical display, switching and maskless lithography systems. Optical and lithographic patterns can be created by modulating individual mirrors in a micromirror array to produce bright and dark spots in an image. The size of our micromirrors can vary in a wide range from more than 10 μm to sub-1 μm. The applications include high-definition projection TV [1], optical switches and display systems, and maskless lithography [2].

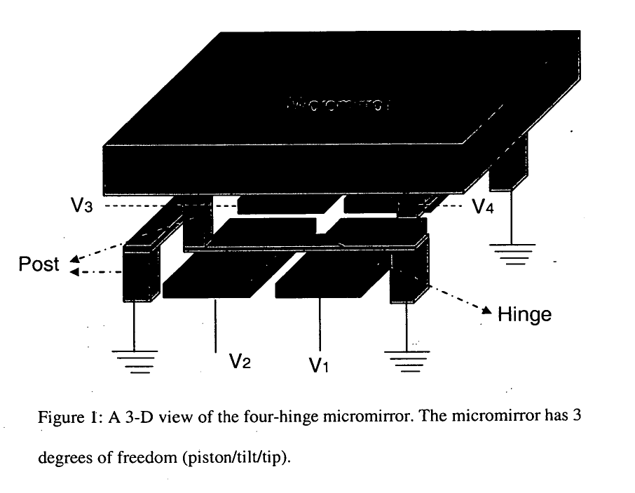

As shown in FIG. 1, the micromirror is supported by four hinges and actuated by four separate electrodes underneath, which allow the micromirror to move vertically, tilt at arbitrary angles, and tip in several directions. The micromirror totally has 3 degrees of motion freedom (piston/tilt/tip) depending on what electrodes are connected to the actuating voltage. Another advantage of this structure is the ability to provide a resistance in the connection to mirror by controlling the resistivity of four hinges and posts using low-temperature CMOS-compatible doped SiGe process. Such a resistance is useful to provide electrical damping (to suppress the mirror vibration), especially if the mirror must be operated in a vacuum environment where no air damping is available. For maskless EUV (13.5 nm) lithography, a reflective multilayer Mo/Si coating [2] can be put on top of micromirrors for imaging purpose; while an Al coating on micromirrors will be suitable for maskless DUV (197 nm and 157 nm) lithography.

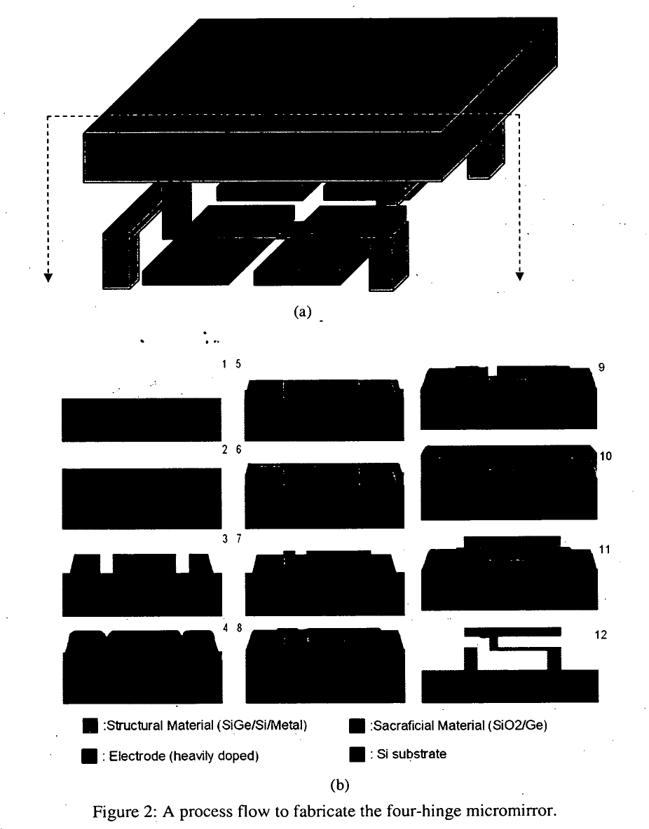

An example of a process sequence to fabricate the four-hinge micromirror is given in FIG. 2. The process shown in FIG. 2(b) describes the cross-section view, as indicated by the arrow in FIG. 2(a), of the micromirror structure at different steps. First, we start with a Si substrate and form the electrode regions in step 1 with photolithography and heavy doping. A sacrificial material (SiO2 or Ge) is deposited in step 2, followed by a contact opening process in step 3. In step 4, we deposit the micromirror structural material which can be SiGe, Si or metal depending on if resistive damping is needed. Next we will only use low-temperature (e.g., <420° C., CMOS compatible) SiGe as structural material to demonstrate the process flow just for the purpose of simplicity. A CMP process will follow in step 5 to remove the top structural layer while leaving the post structures. The deposition material in step 4 can be either conductive or resistive SiGe depending on if the post structures are used to introduce electrical/resistive damping. Low-temperature doped SiGe allows us to control the dopant flow such that the resistivity of the layer can be changed to meet our requirements. After CMP, we deposit the hinge layer using resistive SiGe (step 6) and pattern the hinge areas (step 7). Then we deposit another sacrificial layer in step 8, followed by a contact opening in step 9. Finally, the conductive SiGe mirror layer is deposited (step 10) and patterned (step 11), and the micromirror structure is obtained after the sacrificial material is released in step 12.

### REFERENCES

[1] J. B. Sampsell, “An overview of Texa's Instruments' digital micromirror device (DMD) and its application to projection displays,” Society for Information Display International Symposium Digest of Technical Papers, Vol 24, P. 1012-1015, May 1993.
[2] N. Choksi, Y. Shroff, D. Packard, Y. Chen, W. G. Oldham, M. McCord, R. Pease and D. Markle, “Maskless extreme ultraviolet lithography,” J. Vac. Sci. Technol., B 17(6), P3047-3051, November/December, 1999.

1. Yijian Chen claims that he invents the four-hinge micromirror with 3 degrees of freedom, and he designs a CMOS-compatible low temperature process using several different micromirror structural and sacrificial materials to fabricate this device. The resistive damping can be introduced by using resistive SiGe for hinges and posts. The potential applications include optical display and projection systems, optical switching systems, and maskless lithography.
